(19) United States
(12) Patent Application Publication
(10) Pub. No.: US 2025/0073613 A1
(43) Pub. Date: Mar. 6, 2025

(54) CARBON DIOXIDE SUPERCRITICAL FLUID EXTRACTION APPARATUS

(71) Applicant: Matthew Karl Schweickert, Longmont, CO (US)

(72) Inventor: Matthew Karl Schweickert, Longmont, CO (US)

(21) Appl. No.: 18/734,851

(22) Filed: Jun. 5, 2024

Related U.S. Application Data
(60) Provisional application No. 63/534,883, filed on Aug. 28, 2023.

(51) Int. Cl. B01D 11/02

(52) U.S. Cl. CPC B01D 11/0203; B01D 11/0207

(57) ABSTRACT

A supercritical fluid extraction apparatus is disclosed, including an extraction vessel constructed and arranged to facilitate extraction of one or more desired compounds from a sample media, the separation vessel to permit the precipitation of the extracted compounds from the carbon dioxide stream, and to recirculate and recondition the carbon dioxide stream for continuous closed loop use.

### CROSS-REFERENCE TO RELATED APPLICATIONS

The present application claims priority to U.S. Provisional Application No. 63/534,883 filed Aug. 28, 2023, titled “CARBON DIOXIDE SUPERCRITICAL FLUID EXTRACTION APPARATUS,” which is hereby incorporated by reference in its entirety.

### TECHNICAL FIELD

The embodiments disclosed herein generally relate to a fluid extraction apparatus and more particularly to a carbon dioxide supercritical fluid extraction apparatus.

### BACKGROUND

Carbon dioxide supercritical fluid extraction (SFE) is a method used to extract essential oils, flavors, fragrances, and other compounds from various plants and materials.

SFE involves using carbon dioxide (CO₂) in its supercritical state, where it is maintained at a temperature and pressure above its critical point at about 31.1° C. and 73.8 atm. In this state, CO₂ exhibits both gas-like and liquid-like properties, making it an excellent solvent for extracting various compounds.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a supercritical fluid extraction apparatus, including an extraction vessel constructed and arranged to facilitate extraction of one or more desired compounds from a sample media, the separation vessel to permit the precipitation of the extracted compounds from the carbon dioxide stream, and to recirculate and recondition the carbon dioxide stream for continuous closed loop use.

The disclosed SFE apparatus may be constructed and arranged to condition and supply supercritical carbon dioxide to an extraction vessel that facilitates extraction of desired compounds from a sample media, separates the extracted compounds from the carbon dioxide stream, and recirculates and reconditions the carbon dioxide for continuous closed loop use. In this way, the apparatus may cycle CO2 through a closed-loop process to generate supercritical temperatures and pressures by employing novel methods.

Other SFE apparatuses utilize gaseous CO2 when pumping that results in a design that requires more power and a larger physical footprint when considering comparable apparatus CO2 mass flow rates. Because of the unique way the disclosed apparatus pumps and conditions the CO2, the time required to reach desired extraction/separation temperatures and pressures is significantly less.

In one aspect, the apparatus includes a chiller heat exchanger to cool the carbon dioxide to a sufficient temperature and a sufficient pressure.

In one aspect, the apparatus includes a reservoir to store the cooled and pressurized carbon dioxide.

In one aspect, the reservoir is constructed and arranged to supply liquid carbon dioxide to the extraction vessel to solvate the one or more desired compounds from the sample media.

In one aspect, the apparatus includes a refrigerant condensing unit to sufficiently cool the chiller heat exchanger using a conditioned refrigerant.

In one aspect, the apparatus includes a pump to supply the cooled liquid carbon dioxide to the extraction vessel.

In one aspect, the pump transfers the cooled liquid carbon dioxide through a heater to generate supercritical carbon dioxide within the extraction vessel.

In one aspect, the apparatus includes an automated valve positioned at an exit of the extraction vessel, the automated valve to deposit the supercritical carbon dioxide into the separation vessel wherein the supercritical carbon dioxide is decompressed to precipitate the one or more desired compounds from the carbon dioxide.

In one aspect, the apparatus includes a heated heat exchanger to heat the carbon dioxide to a gaseous state.

In one aspect, the gaseous carbon dioxide is recirculated to the chiller heat exchanger to provide the closed-loop recirculation of the carbon dioxide through the supercritical fluid extraction apparatus.

A method of utilizing a supercritical fluid extraction apparatus is disclosed. First, the extraction vessel is filled with an amount of sample media. Carbon dioxide is supplied from a gas-containing cylinder and passed through a heat exchanger to cool and condense the carbon dioxide. The cooled and condensed carbon dioxide is then stored in a reservoir. A pump transfers the stored carbon dioxide into the extraction vessel by first passing through an extraction heater. The sufficiently heated and pressurized CO2 supplied to the extraction vessel will solvate one or more desired materials from the sample media. The CO2 stream will then continue to a separation vessel where the extracted compounds will precipitate from the CO2. The CO2 will then transfer to a post separation heat exchanger. The carbon dioxide stream is then recirculated to a chiller to cool the carbon dioxide stream to maintain a recirculation flow.

In one aspect, the post-separation process includes the step of heating, via the heat exchanger, the carbon dioxide stream to create a gas.

In one aspect, the method includes the step of removing, via the operator, the one or more desired compounds from the separation vessel.

In one aspect, the method includes the step of inputting, via an electronic controller, one or more operational functions.

In one aspect, the electronic controller is provided on a control panel including a display, wherein the control panel functions as a user interface to receive the one or more operational functions input by the operator.

In one aspect, the one or more operation functions includes at least one of the following: one or more temperatures, one or more pressures, one or more extraction times, one or more amounts of the sample material, and one or more amounts of the one or more desired compounds.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a flowchart of a method of utilizing the carbon dioxide supercritical fluid extraction apparatus, according to some embodiments;

FIG. 2 illustrates a perspective view of the extraction assembly components, according to some embodiments;

FIG. 3 illustrates a perspective view of the chiller, according to some embodiments;

FIG. 4A illustrates a cross-section view of the extraction heater, according to some embodiments;

FIG. 4B illustrates a perspective view of the extraction heater, according to some embodiments;

FIG. 5A illustrates a cross-section view of the post-separation heater, according to some embodiments;

FIG. 5B illustrates a perspective view of the post-separation heater, according to some embodiments;

FIG. 6A illustrates a side elevation view of the pump chiller, according to some embodiments;

FIG. 6B illustrates a perspective view of the pump chiller, according to some embodiments; and

FIG. 6C illustrates a perspective view of the pump chiller, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a carbon dioxide supercritical fluid extraction apparatus constructed and arranged to cycle carbon dioxide through a closed-loop process to generate supercritical temperatures and pressures by employing several unique processes, steps, or methods.

The disclosed SFE apparatus and method may include an extraction vessel in which a material or substance to be extracted is placed. Carbon dioxide gas, as a solvent, may be pressurized and heated until reaching A supercritical state. In this state, carbon dioxide acts as a solvent and may penetrate the material or substance in the extraction vessel dissolving the desired compounds. In an extraction process, the supercritical carbon dioxide may be passed through an extraction vessel where it comes into contact with the substance or material to be extracted. The carbon dioxide may extract the target compounds from the material. In a separation process, the carbon dioxide, now containing the extracted compounds, may be moved to a separate chamber where pressure and temperature are adjusted to return carbon dioxide to a gas state leaving behind the extracted compounds. Extracted compounds may then be collected. Carbon dioxide may be recirculated in a closed loop system.

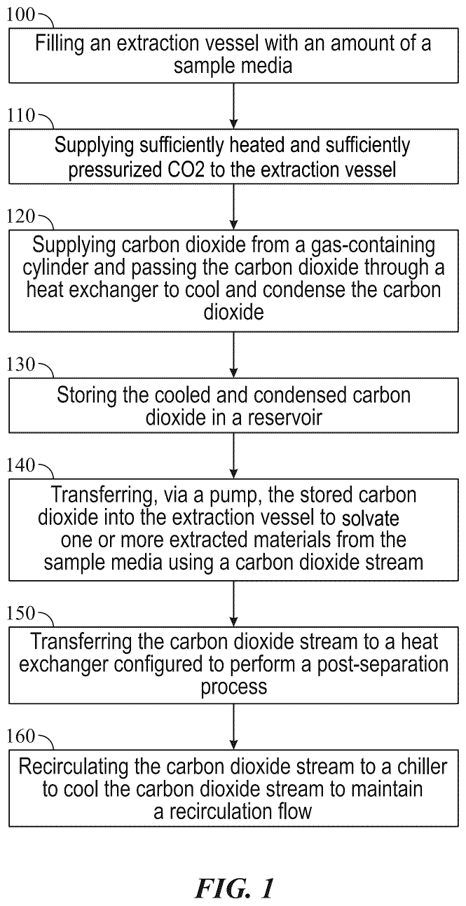

FIG. 1 illustrates a flowchart of a method for utilizing a supercritical fluid extraction apparatus to separate one or more desired compounds from a sample media. In step 100, the extraction vessel is filled with an amount of a sample media. In step 110, the extraction vessel is supplied with sufficiently heated and pressurized CO2. In step 120, carbon dioxide is supplied from a gas-containing cylinder and passed through a heat exchanger to cool and condense the carbon dioxide. In step 130, the cooled and condensed carbon dioxide is stored in a reservoir. In step 140, a pump transfers the stored carbon dioxide into the extraction vessel to solvate one or more extracted materials from the sample media using a carbon dioxide stream. In step 150, the carbon dioxide stream is transferred to a heat exchanger configured to perform a post-separation process. In step 160, the carbon dioxide stream is recirculated to a chiller to cool the carbon dioxide stream to maintain a recirculation flow.

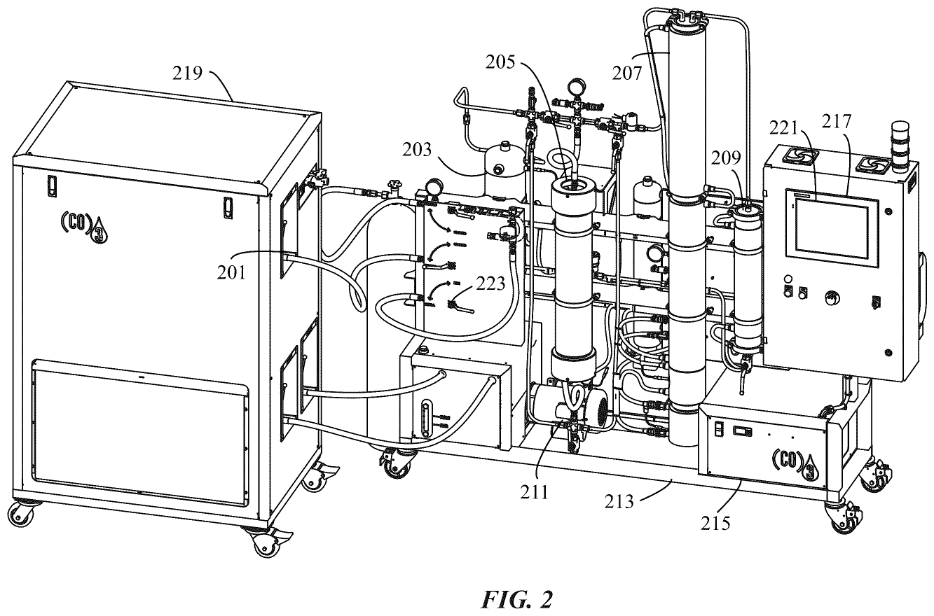

Components of the supercritical fluid extraction apparatus are illustrated in FIGS. 2-6C. FIG. 2 illustrates the extraction assembly components including the reservoir 201, heater 203, extraction vessel 205, separation vessel 207, heated heat exchanger 209, pump 211, primary extraction device 213, pump chiller 215, controller 217, and chiller 219. An operator may fill in the extraction vessel 205 with sample media and seal the extraction vessel 205. Sample media may include dehydrated organic materials, flowers, herbs, or spices, and the like. Subsequently, the extraction vessel 205 and a chiller 219 may be brought to the appropriate temperature and pressures prior to cycling carbon dioxide through the necessary steps of the process. Appropriate chiller reservoir 201 temperature and pressures may typically range from 0-26 degrees Fahrenheit and 425-650 PSI, respectively. Extraction vessel 205 temperatures and pressures will be brought to the desired values when CO2 starts to cycle through the system and is pressurized and heated. Carbon dioxide may be supplied from a gas-containing cylinder and passed through a heat exchanger 300, cooled and condensed, and then stored in a chilled state in a reservoir 201. The reservoir 201 may be constructed and arranged to supply liquid carbon dioxide to a primary extraction device 213.

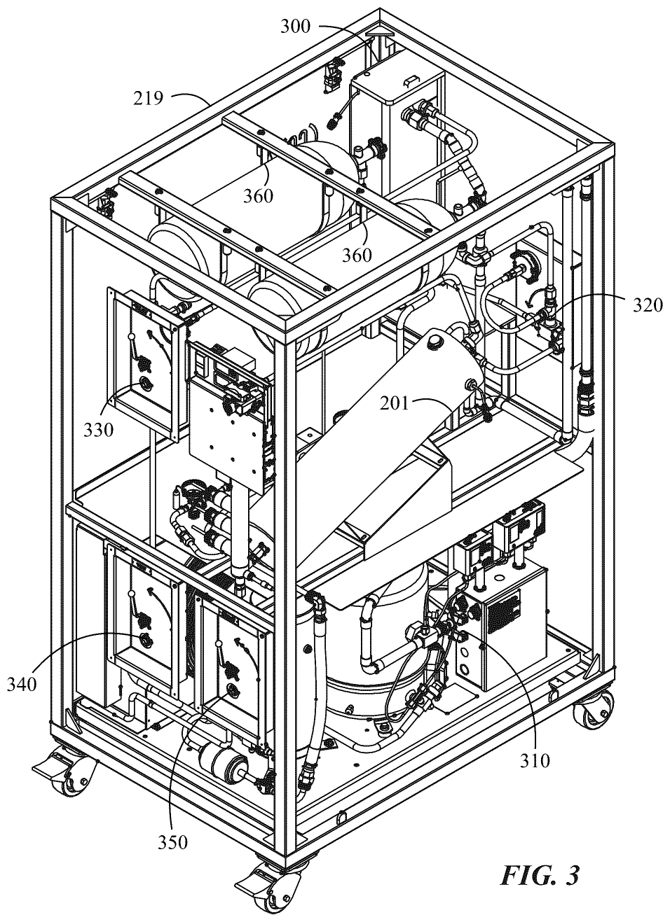

The chiller heat exchanger 300 and liquid reservoir 201 are sufficiently cooled with conditioned refrigerant supplied by a refrigerant condensing unit 310. The chiller heat exchanger 300 is a metallic plate style exchanger and must be positioned in the vertical orientation as shown in FIG. 3 and connected to the inlet and outlet CO2 and refrigerant streams in a manner, so they are counter to each other as to maximize efficiency of the chiller heat exchanger 300. The liquid reservoir 201 is cooled by a metal tube coil surrounding the main vessel of the reservoir 201. The refrigerant stream is channeled through this coil. A glycol based heat transfer liquid of suitable properties resides within the shell that contains the coil and the vessel. In this way the vessel is cooled directly by conduction through contact with the coil but also through convection by way of the cooled heat transfer fluid.

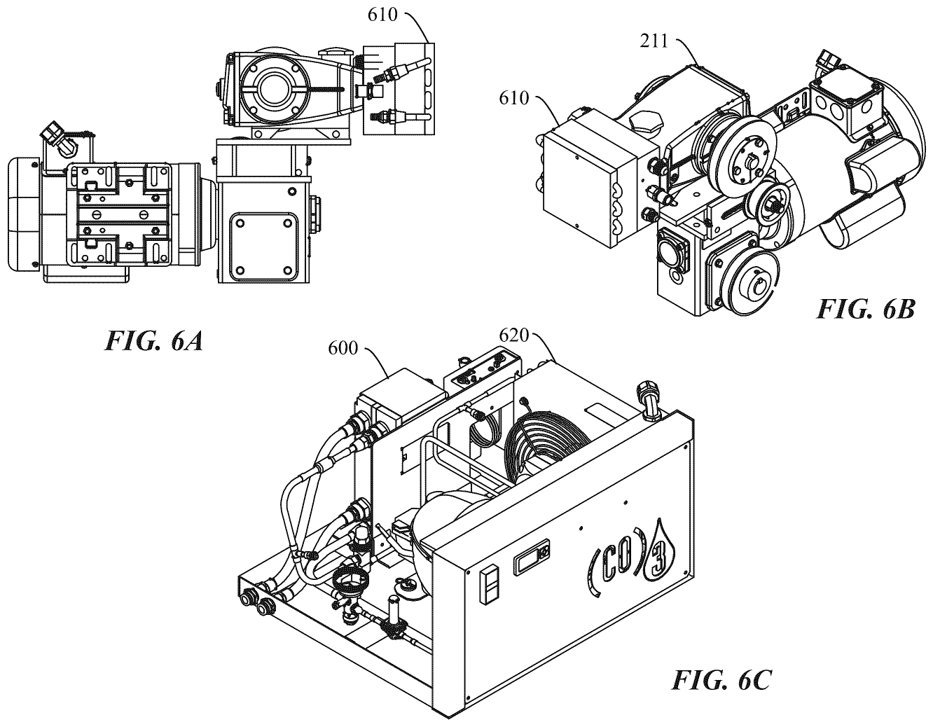

As shown in FIG. 6A, FIG. 6B, and FIG. 6C, supplied liquid carbon dioxide from the chiller 219 may enter a pump 211 of the main extraction apparatus. As to avoid undesirable heating of the CO2 as it enters the pump 211, the pump 211 must be cooled sufficiently. This is accomplished by utilizing a cooled sourced of glycol based heat transfer fluid that will cool the pump head by means of a chill plate 610 and circulating the fluid through the flush ports of the pump 211 itself. A chill plate 610 is attached to the vertical face of the pump. A pump chiller 215 assembly resides near the pump 211 in the main extraction assembly and contains a heat exchanger 600 and a refrigerant condensing unit 620. The heat exchanger 600 is connected to the condensing unit as to supply the exchanger with adequately cooled refrigerant. The heat transfer fluid will be circulated through the cooled heat exchanger, drop in temperature, flow to the chill plate, through the flush ports of the pump 211, and deposit into a reservoir. From the reservoir a circulation pump will circulate the fluid back to the heat exchanger to continue the supply of cooled fluid back to the pump 211.

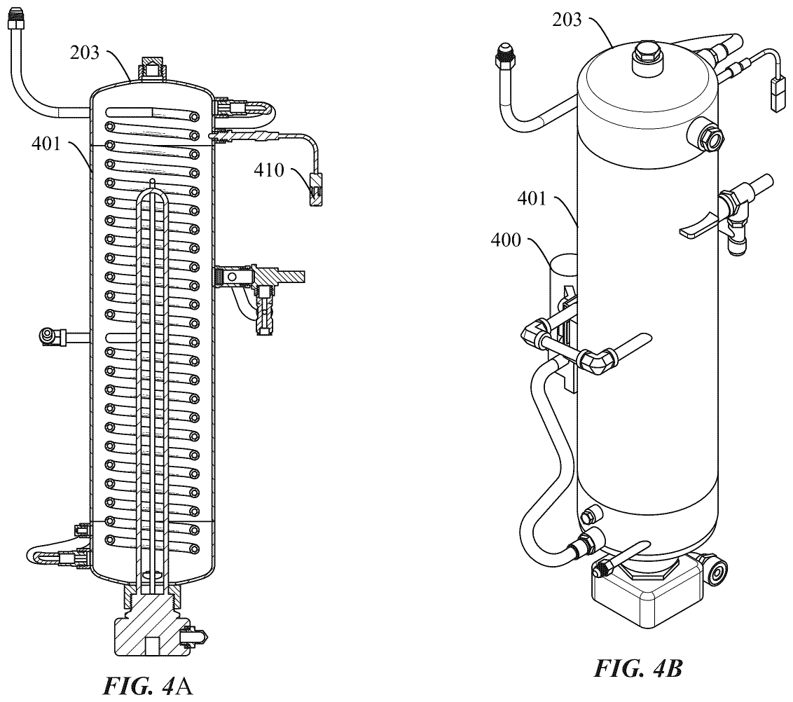

In reference to FIG. 4A and 4B, after leaving the pump the carbon dioxide passes through a heater 203, is heated and then deposited into an extraction vessel. The heater 203 is constructed of a metallic tank 401 within which resides a metallic tube coil and a powered heating element. The tank is filled with a glycol based heat transfer liquid of suitable properties. The heating element transfers heat to the fluid which then in turn heats up the internal coil. As the CO2 stream passes through this heated coil, the stream will be sufficiently heated. To aid in a more uniform heat transfer along the full length of the coil, a circulation pump 400 is used to circulate the heat transfer fluid from one end of the heater tank to the other. Near the outlet of the heater 203 resides a temperature sensor 410 that will provide feedback to the control electronics which in turn controls power to the heating element. When the heat transfer fluid is maintained to a certain temperature range, the outlet stream of heated CO2 can be controlled to be within the user's desired extraction temperature.

As the extraction vessel 205 fills, pressure rises, and in combination with increased temperature, the carbon dioxide present in the extraction vessel 205 will reach desired supercritical temperatures and pressures. Extraction temperature can range depending on user's desire ranging from chiller reservoir 201 temperature to 120 degrees Fahrenheit. Extraction pressure can range from slightly elevated above chiller reservoir 201 pressure to 5000 PSI.

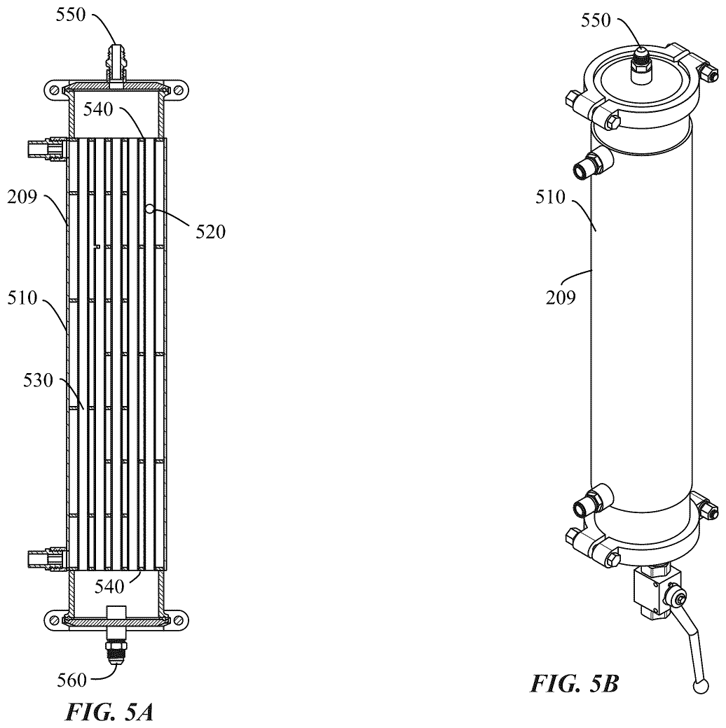

Upon reaching desired pressure and temperatures within the extraction vessel 205, the extraction process may proceed starting with the opening of an automated valve at the exit of the extraction vessel 205 in order to deposit carbon dioxide into the separation vessel 207. As the carbon dioxide stream enters the separation vessel 207, decompression of the carbon dioxide stream occurs allowing the extracted materials to precipitate from the carbon dioxide. The separation vessel 207 may be heated to prevent severe temperature drop during decompression. Following precipitation of the carbon dioxide from the stream, this stream may enter a heated heat exchanger 209 (see FIG. 5A and FIG. 5B).

Following precipitation of carbon dioxide, the fluid stream may enter post-separation process within the heat exchanger 209 to continue to heat the stream to the point where carbon dioxide becomes gaseous. The gaseous stream may exit the heat exchanger 209 and be recirculated to the chiller 219 where the gaseous carbon dioxide stream may be chilled and condensed back into a liquid for a recirculation. This post-separation heat exchange process is constructed and arranged to supply gaseous carbon dioxide to the chiller 219 and maintain a recirculating flow.

As shown in FIG. 5A and FIG. 5B, the post-separation heat exchanger 209 is a shell and tube style exchanger constructed of a tank 510 with internal tubing 520 and baffles 530. A heated stream of glycol based heat transfer fluid enters the tank 510 at and travels through the cavity inside the tank 510 bounded by the tank inside walls, the end caps 540 at either end of the tank 510, and outside surfaces of the tubes. The baffles 530 present within this cavity help direct the flow of the fluid over the full length and circumference of the tube's unit exiting at the outlet of the tank. CO2 will enter the exchanger at 550, travel through the heat tubes making contact with the heated surfaces and exit the exchanger at 560 at a higher temperature. This post-separation heat exchange process is constructed and arranged to supply gaseous carbon dioxide to the chiller 219 and maintain a recirculating flow.

Following extraction, and operator may remove extracted materials from the system.

After the extraction and separation process has completed the operator may recapture and store residual CO2 left in the system. By changing the position of the Refill 3-way valve 223, the operator may run the pump 211 and deposit the CO2 into an awaiting connected gas cylinder. As a result of pumping the CO2 out of the system, the supply of liquid CO2 in the chiller reservoir 201 will drop in pressure to the point it is below the minimum allowable for the pump 211 to operate effectively. At this point the operator will stop pumping, change the position of the Storage valve 320 in the chiller 219, close the Outlet valve 350, and close the Vent valve 340, and keep the Inlet valve 330 open. The positioning of these valves will contain the CO2 to with the storage tanks 360 and the liquid reservoir 201. The chiller 219 can then be power down, and as a result, the contained CO2 will rise in temperature and pressure. The extra volume afforded by the storage tanks 360 will guarantee that the maximum allowable pressure contained within will not be exceeded.

In this way, the system may novelty cycles CO2 through a closed loop process to generate supercritical temperatures and pressures by supplying A heated carbon dioxide stream to an extraction vessel 205 instead of passively heating carbon dioxide by heating the extraction vessel 205 and by utilizing a post-separation heat exchanger to facilitate chilling and condensing and use of a liquid carbon dioxide supply.

In some embodiments, a controller 217 is provided to allow for the input of operational controls into the computer of the system. The controller 217 may be an electronic controller provided on a control panel and may include a display 221 to provide a user interface. The controller may also include a plurality of buttons or other tactile control elements which can be used to input the various operational functions.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A supercritical fluid extraction apparatus, comprising:
an extraction vessel constructed and arranged to facilitate extraction of one or more desired compounds from a sample media, the separation vessel to permit the precipitation of the extracted compounds from the carbon dioxide stream, and to recirculate and recondition the carbon dioxide stream for continuous closed loop use.

2. The supercritical fluid extraction apparatus of claim 1, further comprising a chiller heat exchanger to cool the carbon dioxide to a sufficient temperature and a sufficient pressure.

2. upercritical fluid extraction apparatus of claim 2, further comprising a reservoir to store the cooled and pressurized carbon dioxide.

4. The supercritical fluid extraction apparatus of claim 3, wherein the reservoir is constructed and arranged to supply liquid carbon dioxide to the extraction vessel to solvate the one or more desired compounds from the sample media.

5. The supercritical fluid extraction apparatus of claim 4, further comprising a refrigerant condensing unit to sufficiently cool the chiller heat exchanger using a conditioned refrigerant.

5. upercritical fluid extraction apparatus of claim 5, further comprising a pump to supply the cooled liquid carbon dioxide to the extraction vessel.

7. The supercritical fluid extraction apparatus of claim 6, wherein the pump transfers the cooled liquid carbon dioxide through a heater to generate supercritical carbon dioxide within the extraction vessel.

8. The supercritical fluid extraction apparatus of claim 7, further comprising an automated valve positioned at an exit of the extraction vessel, the automated valve to deposit the supercritical carbon dioxide into the separation vessel wherein the supercritical carbon dioxide is decompressed to precipitate the one or more desired compounds from the carbon dioxide.

9. The supercritical fluid extraction apparatus of claim 8, further comprising a heated heat exchanger to heat the carbon dioxide to a gaseous state.

10. The supercritical fluid extraction apparatus of claim 9, wherein the gaseous carbon dioxide is recirculated to the chiller heat exchanger to provide the closed-loop recirculation of the carbon dioxide through the supercritical fluid extraction apparatus.

11. A supercritical fluid extraction apparatus, comprising:
an extraction vessel constructed and arranged to facilitate extraction of one or more desired compounds from a sample media;
a chiller heat exchanger to cool the carbon dioxide to a sufficient temperature and a sufficient pressure to generate liquid carbon dioxide, the chiller heat exchanger cooled via a refrigerant condensing unit;
a reservoir to store the liquid carbon dioxide, the reservoir to supply liquid carbon dioxide to the extraction vessel via a pump;
a heater to heat the liquid carbon dioxide to generate supercritical carbon dioxide within the extraction vessel
an automated valve positioned at an exit of the extraction vessel, the automated valve to enable the transfer of the supercritical carbon dioxide to a separation vessel, the separation vessel to enable the decompression of the supercritical carbon dioxide, wherein the decompression causes the one or more desired chemicals to solvate from the liquid carbon dioxide
a heated heat exchanger to heat the carbon dioxide to generate the gaseous carbon dioxide, wherein the gaseous carbon dioxide is transferred through a recirculation system to recirculate and recondition the gaseous carbon dioxide to provide a continuous closed loop system.

12. The supercritical fluid extraction apparatus of claim 11, further comprising an electronic controller to permit an operator to control one or more operational functions of the supercritical fluid extraction apparatus.

13. The supercritical fluid extraction apparatus of claim 12, wherein the electronic controller enables the operator to preprogram the one or more operation functions.

14. The supercritical fluid extraction apparatus of claim 13, wherein the controller is provided on a control panel and a display screen to provide a user interface capable of receiving one or more inputs from the operator.

15. A method of utilizing a supercritical fluid extraction apparatus, the method comprising the steps of:
filling an extraction vessel with an amount of a sample media;
supplying sufficiently heated and sufficiently pressurized CO2 to the extraction vessel;
supplying carbon dioxide from a gas-containing cylinder and passing the carbon dioxide through a heat exchanger to cool and condense the carbon dioxide;
storing the cooled and condensed carbon dioxide in a reservoir;
transferring, via a pump, the stored carbon dioxide into a extraction vessel to solvate one or more extracted materials from the sample media using a carbon dioxide stream;
transferring the carbon dioxide stream to a heat exchanger configured to perform a post-separation process; and
recirculating the carbon dioxide stream to a chiller to cool the carbon dioxide stream to maintain a recirculation flow.

16. The method of claim 15, wherein the post-separation process includes the step of heating, via the heat exchanger, the carbon dioxide stream to create a gas.

17. The method of claim 16, further comprising the step of removing, via the operator, the one or more desired compounds from the separation vessel.

18. The method of claim 17, further comprising the step of inputting, via an electronic controller, one or more operational functions.

19. The method of claim 18, wherein the electronic controller is provided on a control panel including a display, wherein the control panel functions as a user interface to receive the one or more operational functions input by the operator.

20. The method of claim 19, wherein the one or more operation functions includes at least one of the following: one or more temperatures, one or more pressures, one or more extraction times, one or more amounts of the sample material, and one or more amounts of the one or more desired compounds.
